(19) United States
(12) Patent Application Publication
(10) Pub. No.: US 2016/0012711 A1
(43) Pub. Date: Jan. 14, 2016

(54) System and Method Identifying Unevacuated Facility Residents During An Emergency Condition

(71) Applicant: Honeywell International Inc., Morristown, NJ (US)

(72) Inventors: Sriramakrishnan Swaminathan, Bangalore (IN); Kanimoli Singaravelu, Bangalore (IN); Tinu Thampi Pattasseril, Cochin (IN)

(21) Appl. No.: 14/325,689

(22) Filed: Jul. 8, 2014

(51) Int. Cl. G08B 25/01; G08B 25/10

(52) U.S. Cl. CPC G08B 25/016; G08B 25/10

(57) ABSTRACT

A system to detect an alarm condition in a predetermined facility is coupled to a data acquisition system which collects information as to condition and location of residents of the facility. In response to detection of the alarm condition, the data acquisition system automatically forwards resident condition and location information to a filter module. That module filters the information to determine which residents still are in the facility and need to be evacuated. Information as to such residents can be graphically presented on a per floor basis of the facility substantially in real-time to facilitate first responders in the evacuation of those residents.

### FIELD

The application pertains to systems and methods to facilitate evacuation of patients or residents of a facility in response to detection of an emergency condition. More particularly, the application pertains to such systems and methods which can provide patient location information to first responders in the event of a detected emergency condition, such as a fire.

### BACKGROUND

Evacuating patients from a hospital, or residents of a facility in response to detection of an emergency condition can be a difficult and dangerous activity. During fire incidents in hospitals it can be very time consuming to get the details, such as room, bed, location, without limitation of non-ambulatory patients, or patients who are present in a fire incident. Sometimes non-ambulatory patients have died in the fire incidents without proper attention.

The problem is especially acute for non-ambulatory patients who are in unconscious state. For example, those in a coma, mentally affected, new born children become victims of fire incidents, or other types of emergency conditions, due to lack of information about their presence and condition. It is thus a huge effort and a time consuming process to search all the rooms of a large hospital.

With current processes, the fire fighters collect the data from hospital administrators and then they start rescue operations. Distribution of rescue team and attack area is often discussed only after collecting all information. Patients' evacuation status is known only after reaching the respective room or rooms.

The above process results in delayed information collection as to the status and location of various patients. It does not provide a proactive rescue plan with live, real time, data as to the location of patients who are yet to be evacuated.

There is thus a continuing need to provide more and better information as to location and status of patients, or residents still in need of evacuation.

### BRIEF DESCRIPTION OF THE DRAWINGS

FIG. 1 is a diagram of a system in accordance herewith;

FIG. 2 is a diagram which provides additional information as to the system of FIG. 1;

FIG. 3 is a flow diagram of an exemplary process in accordance herewith; and

FIG. 4 is a diagram illustrating an alternate embodiment in accordance herewith.

### DETAILED DESCRIPTION

While disclosed embodiments can take many different forms, specific embodiments hereof are shown in the drawings and will be described herein in detail with the understanding that the present disclosure is to be considered as an exemplification of the principles hereof, as well as the best mode of practicing same, and is not intended to limit the claims hereof to the specific embodiment illustrated.

Those of skill will understand that embodiments hereof are applicable to a variety of instructions which provide care to a plurality of individuals. These include, without limitation, hospitals, retirement residences, youth centers, and prisons.

By way of example only, the present system and method are useful in a hospital setting where the local alarm system has detected a fire condition. In this instance, the fire is automatically reported to the nurse call system. One or more nurse call stations are usually located on each floor of such institutions. The nurse call system, in response to the fire indicating signal, collects data as to patient locations from the hospital premises. The data is collected from the existing sensors, for example, bed sensors, wrist bands, baby pendants, dementia patient transponders, of the nurse call system.

The collected sensor inputs are forwarded to a filter module. The filter module filters patient data to determine those individuals who is/are not yet evacuated as well as their location details. Then the filtered data can be forwarded to a floor plotting module which plots a graphical representation of the floor plan of the facility. It will be understood that the various modules can be implemented in part with circuitry, programmable processors, servers and in part with software executable on one or more processors or servers. For example, the filter module can reside in the nurse call system or server . Alternately, the other modules could be implemented on the nurse call system or server, or displaced servers or processors.

The patient location data is then transferred via Internet to cloud or local servers and/or smart mobile devices in the possession of first responders. The data can be accessed from cloud or local servers to plan a rescue operation. The updated data indicative of the patients, or residents, who are not yet evacuated can be obtained from cloud or local servers at any point of time during the rescue operation.

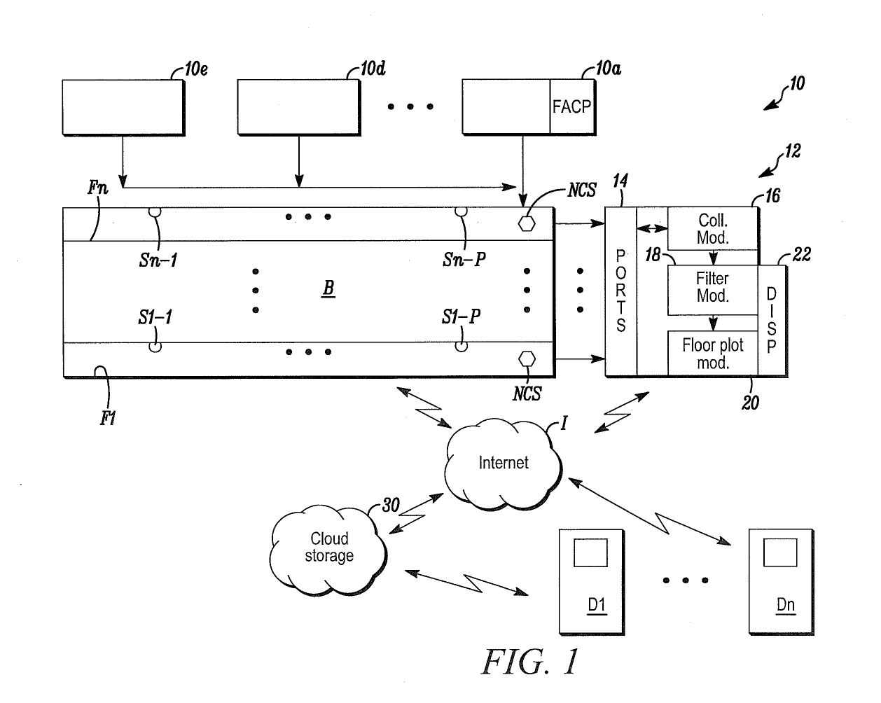

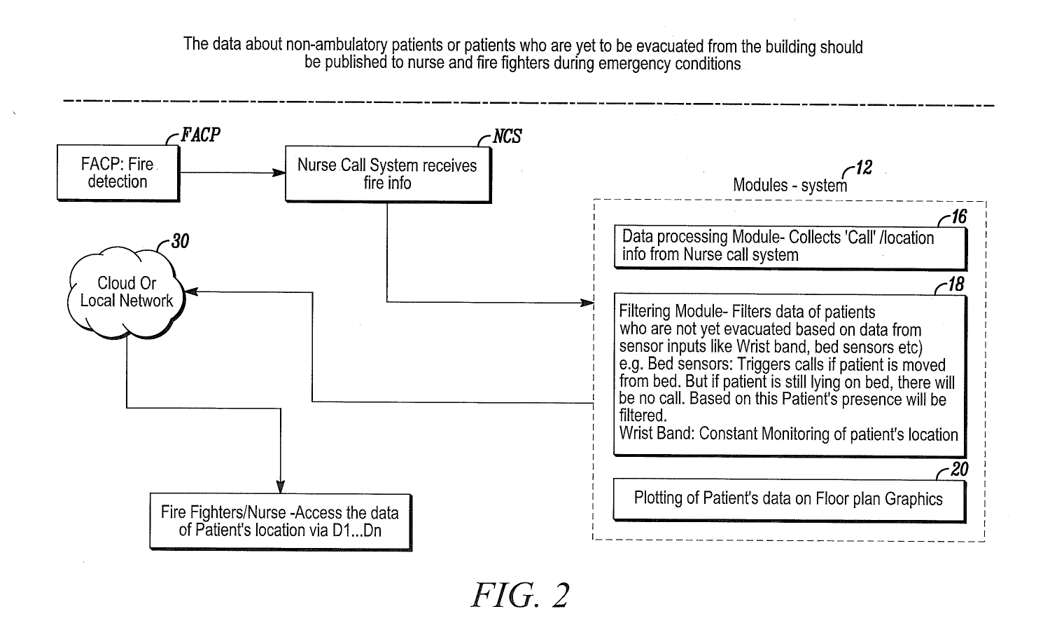

FIGS. 1, 2 illustrate aspects of a system 10 in accordance herewith. A treatment and/or residence building B with multiple floors such as F1 . . . Fn could include a nurse call system which might include one or more nurse call stations NCS on each of the floors Fi of the building B. As those of skill will understand, outputs from a plurality of sensors associated with patients, or residents on each of the floors Fi can be fed to the respective NCS on that floor and would be available to the building nurse call system.

Such buildings would also include a fire monitoring system, for example system 10a, with a plurality of smoke, or fire detectors on each floor such as S1-1 . . . S1-p . . . Sn-1. . . Sn-p. All such detectors would be coupled, wired or wirelessly, to a fire alarm control panel FACP on or in close proximity to the building B.

It will be understood that the incident initiating condition is not limited to detecting a fire condition. For example, the present system and method can be used in combination with gas monitoring system 10b to sense the presence of a dangerous gas, a loss of electricity, a loss of air conditioning or heat via a heating, ventilation, air condition system (HVAC) 10d or any other condition indicating indicium all without limitation and to provide evacuation assistance, as discussed above, for first responders. In response to detecting the respective emergency condition, the respective monitoring system automatically notifies the nurse call system of the facility.

As illustrated in FIG. 1, a real-time resident, or patient, locating system 12 is provided. System 12 could include a plurality of ports 14 coupled to the nurse call system, and the NCS stations. In response to receiving the incident indicating signal from the respective monitoring system, the nurse call system forwards resident information to the system 12. System 12 can be located in or near the nurse call system, or in or near one or more of the monitoring systems, without limitation.

Additionally the system 12 could include a data, or information, collection module 16 which receives patient or residence location/condition signals from the nurse call system and via ports 14. The collection module 16 in turn couples the received data or information to a filter module 18 which determines which patients or residents are not yet evacuated based on received sensor information.

Information as to those patients or residents not yet evacuated can be plotted on a per floor basis in a floor plan module 20 to provide a graphic per floor display, on display unit 22 as to patient or residence locations as well as conditions of those individuals. Display unit 22 can be a display of the nurse call system or server, or any other server displaced or local easily accessible to nurses, security personnel or first responders.

In addition to a local display, patient location and condition information can be transmitted via the Internet I to displaced cloud storage 30. Such information can then be made available to first responders via their wireless devices D1 . . . Dn even before they arrive at the scene. Further, the patient location information can be transmitted back to the nurse call server, or any other available server via the internet I or any other means for nurses, security personnel or first responders can access it.

It will be understood that the system 10 of FIG. 1 is exemplary only. Some or all of the resident, or patient, locating system 12 could be implemented at one or more displaced servers which then load the real-time patient or resident information into the cloud storage 30 for use by the first responders. The various modules of system 12 can be implemented in part with dedicated control circuits in combination with one or more programmable processors and executable software. The locations of such circuitry, processors or circuitry are not limitations hereof. Alternately, the various modules 16, 18,20 can be implemented in a selected server, for example, the nurse call server, or any other location as desired.

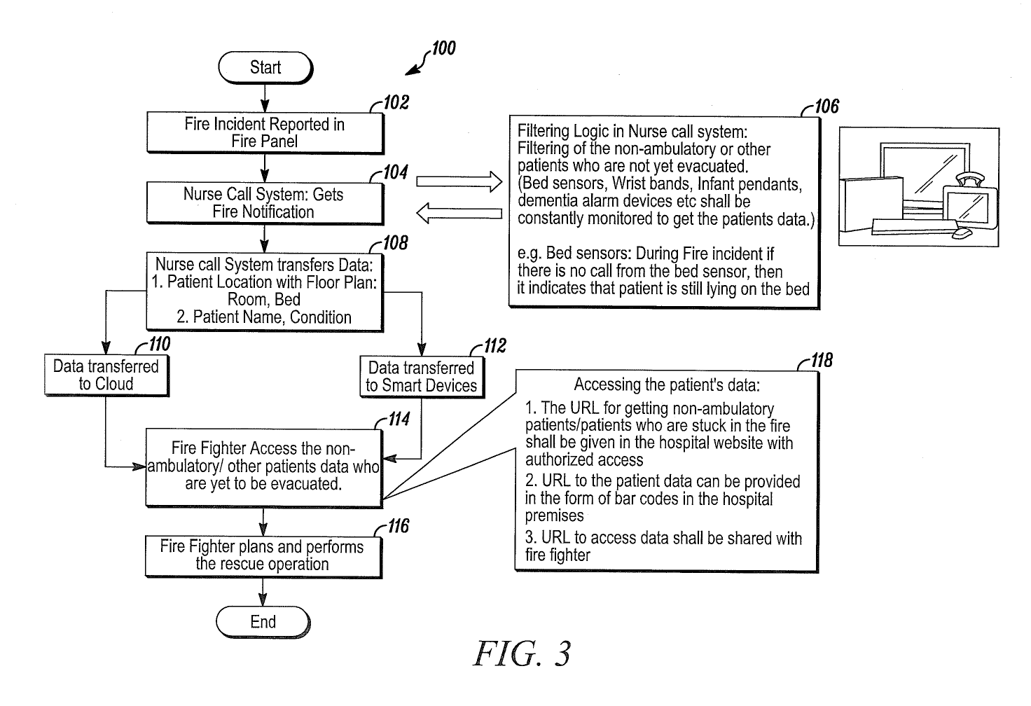

FIG. 3 is a flow diagram of one exemplary process 100 in accordance herewith. A fire incident is reported to the FACP, as at 102. The nurse call system can be alerted to the detected fire condition as at 104.

The filtering process can be implemented as at 106, in the nurse call system or elsewhere as discussed above. The nurse call system can transfer data as to patient location and condition, in conjunction with the floor plan, as at 108.

Data can be transferred to Cloud Storage 30, as at 110 and/or to smart devices, D1 . . . Dn, as at 112. The fire fighters can be provided access to data of residents or patients who are yet to be evacuated as at 114. An evacuation or rescue operation can be developed as at 116.

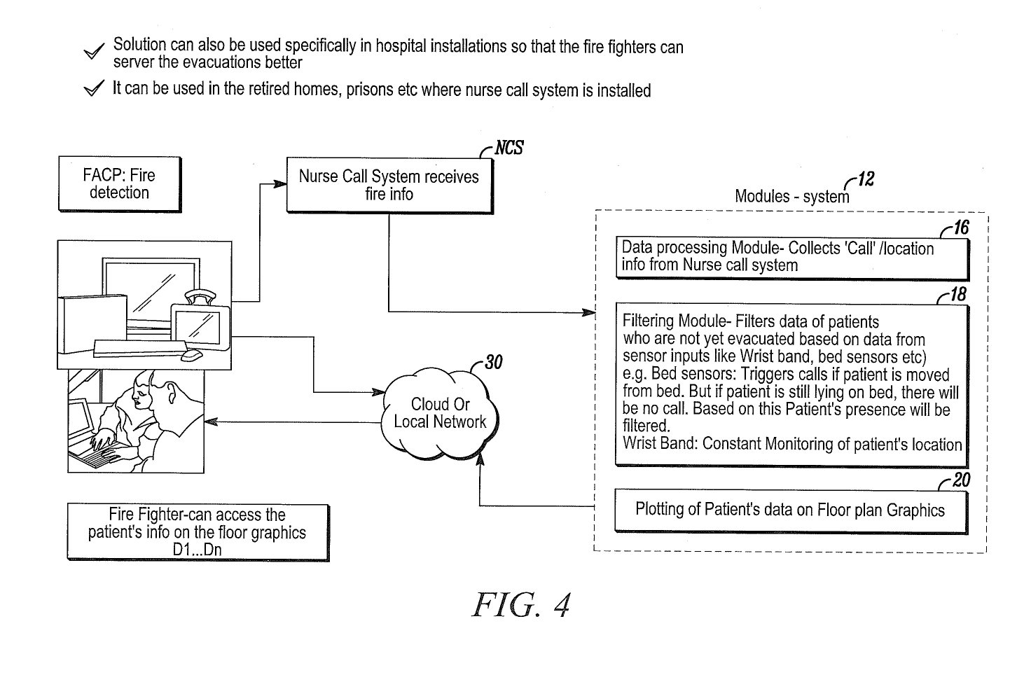

FIG. 4 illustrates the system 10 installed in a nursing home, retirement community or prison. System 10 could also be installed in other types of residential facilities all without limitation. It will also be understood that in some embodiments the facility may not include a nurse call system. Other types of resident, or patient, data collection systems come within the spirit and scope hereof.

In summary, in a disclosed embodiment, the fire alarm system detects a fire in the hospital. The fire is reported to the nurse call system. The nurse call system collects data concerning the patients' location from the hospital sensors. The data is collected from the existing sensors, for example, bed sensors, wrist bands, baby pendants, dementia patient transponders of the nurse call system.

The collected sensor inputs are forwarded to the filter module. That module filters the data or sensor outputs of patients to determine those who are not yet evacuated along with their location details.

The filtered data is then plotted on the floor plan graphics. The data can then transferred to cloud or local servers or available mobile devices. The fire fighters, nurses or administrators can access the data from the cloud, or local server and plan the rescue operation. The updated data of the patients who are not yet evacuated can be obtained from cloud or local server at any point of time during the rescue operation.

From the foregoing, it will be observed that numerous variations and modifications may be effected without departing from the spirit and scope of the invention. It is to be understood that no limitation with respect to the specific apparatus illustrated herein is intended or should be inferred. It is, of course, intended to cover by the appended claims all such modifications as fall within the scope of the claims.

Further, logic flows depicted in the figures do not require the particular order shown, or sequential order, to achieve desirable results. Other steps may be provided, or steps may be eliminated, from the described flows, and other components may be add to, or removed from the described embodiments.

1. A method comprising:
providing a condition monitoring system;
using the monitoring system to detect an emergency event at a predetermined premises;
collecting at a predetermined site information as to location of members of a selected group of individuals who are associated with the premises;
determining which members are still at the premises; and
associating the members still at the premises with positions on a floor plan.

2. A method as in claim 1 including transferring position information to at least one local mobile device.

3. A method as in claim 2 which includes displaying position and member indicia on at least one of the devices.

4. A method as in claim 3 which includes obtaining information as to members still in need of evacuation.

5. A method as in claim 1 where collecting includes using existing sensors of a call system to collect individual location information.

6. A method as in claim 5 where determining includes filtering patient information to determine those individuals not yet evacuated and providing details of their locations.

7. A method as in claim 6 which includes associating individuals not yet evacuated with floor plan locations.

8. A method as in claim 7 which includes storing the associated individual information and floor plan locations.

9. A method as in claim 8 which includes downloading at least some of the stored individual information and floor plan locations.

10. A method as in claim 9 which includes accessing pre-stored patient information and floor plan locations to determine those patients that still need evacuation.

11. An apparatus comprising:
a plurality of sensor signal input ports;
a first module to evaluate signals from the input ports;
a second module that determines which signals indicate the presence of an individual at a predetermined location; and
at least one output device, coupled to information which indicates the presence of the individual at the predetermined location to present a display pertaining to the individual at the predetermined location.

12. An apparatus as in claim 11 where the second module includes a filtration module to determine which individuals are still at the predetermined location and which are no longer present there.

13. An apparatus as in claim 11 which is coupled to a nurses call system wherein the call system couples signals from sensors associated with a plurality of individuals to the sensor signal input ports.

14. An apparatus as in claim 13 which presents information as to the current location of individuals on a per floor basis of a selected facility.

15. An apparatus as in claim 11 wherein the first module includes a data processing module which collects call or location information received at the input ports from a nurse call system, where the second module includes a filtering module which provides information as to the current location of individuals on a per floor basis of a selected facility, and where the location information can be provided on a per floor basis at one or more sites.

16. An apparatus as in claim 11 which includes a regional monitoring system coupled to a plurality of sensors associated with individuals at the predetermined location.

17. An apparatus as in claim 16 wherein the plurality of sensors comprises a nurses call system.

18. An apparatus as in claim 17 wherein the regional monitoring system is selected from a class which includes at least a fire monitoring system, a gas monitoring system, an electrical monitoring system, and an HVAC monitoring system.

19. An apparatus as in claim 15 which includes a plurality of physiological sensors coupled to the input ports and wherein information as to current locations of individuals, present on a floor of the facility, is stored and accessible by the at least one output device.

20. An apparatus comprising a monitoring system to detect an alarm condition in a predetermined facility, the monitoring system is coupled to a data acquisition system which collects information as to condition and location of residents of the facility, wherein, in response to detection of the alarm condition, the data acquisition system automatically forwards resident condition and location information to a filter module, the filter module processes the information to determine which residents still are in the facility and need to be evacuated, information as to such residents can be graphically presented on a per floor basis of the facility substantially in real-time to facilitate first responders in the evacuation of those residents.
